(19) United States
(12) Patent Application Publication
(10) Pub. No.: US 2011/0089774 A1
(43) Pub. Date: Apr. 21, 2011

(54) TRANSVERSE FLUX MOTOR WITH INTEGRAL COOLING

(76) Inventor: Dennis A. Kramer, Troy, MI (US)

(21) Appl. No.: 12/977,214

(22) Filed: Dec. 23, 2010

Related U.S. Application Data
(63) Continuation-in-part of application No. 11/699,931, filed on Jan. 30, 2007, now abandoned.

(51) Int. Cl. H02K 19/06; H02K 1/02

(52) U.S. Cl. 310/44; 310/46

(57) ABSTRACT

A transverse flux, switched reluctance motor includes a stator, a rotor mounted for rotation relative to the stator about an axis, and a plurality of phased coils. The stator and rotor are spaced apart from each other by a gap and a first phased coil is positioned to extend at least partially across the gap.

### RELATED APPLICATION

This application is a continuation-in-part of application Ser. No. 11/699,931, which was filed on Jan. 30, 2007.

### BACKGROUND OF THE INVENTION

This application relates to an improved motor that is configured to provide a maximum coil winding area.

Traction motors are often required to provide electrical to mechanical conversion for commercial vehicle drive trains. Typically the traction motors used in drive train applications have been three phase AC induction machines. A three phase AC induction machine is a machine that utilizes an induction motor to turn three phase electrical energy into mechanical motion. The primary reason for the use of AC induction machines as traction motors is that AC induction machines are easy to build and use well established technology. The fact that the technology behind AC induction machines is well established and has a large infrastructure allows them to be produced in a relatively inexpensive manner.

On the other hand, large cost, size, and weight penalties are incurred when standard AC induction machines are adapted to vehicle drive trains. As such, much research has been put into developing new motor designs that can satisfy the cost, size and weight requirements of commercial vehicles.

Typically a goal has been to make induction machines more effective by increasing the output torque while decreasing the overall weight and cost of the machine. Transverse flux machines are the most viable method to fulfill this goal. Two types of transverse flux machines are known in the art, the permanent magnet transverse flux machine and the switched reluctance transverse flux machine. Permanent magnet transverse flux machines are transverse flux machines which utilize a permanent magnet, usually constructed of rare-earth materials, as part of their rotor construction. Permanent magnet transverse flux machines achieve a high torque per weight ratio. However, permanent magnet transverse flux machines are not optimal. They are difficult to manufacture due to the complex magnet mounting methods used to construct the windings required for machine construction. Also, the torque output of such a machine is temperature dependant, and they are highly intolerant of electrical fault conditions.

Switched reluctance machines have several distinct advantages over permanent magnet machines. First, switched reluctance machines provide relatively temperature independent torque, and second, switched reluctance machines are more tolerant of fault conditions. Switched reluctance motors work on the principle that a rotor pole pair has a tendency to align with a charged stator pole pair. By sequentially energizing stator windings the rotor is turned as it realigns itself with the newly energized stator poles in each energization. This allows the production of mechanical movement within the machine without the use of rare-earth materials. Switched reluctance machines have not been developed as much as permanent magnet machines due to, among other reasons, high investment costs in the electronic controls development. Current switched reluctance machines use radially spaced phases and have multiple windings per phase that are more difficult to assemble.

### SUMMARY OF THE INVENTION

A transverse flux, switched reluctance motor includes a stator, a rotor mounted for rotation relative to the stator about an axis, and a plurality of phased coils. The stator and rotor are spaced apart from each other by a gap.

In one example, a first phased coil extends at least partially across the gap.

In one example, the stator comprises a plurality of stator portions that are spaced apart from each other along the axis, and the rotor comprises a plurality of rotor portions with each rotor portion being associated with corresponding stator portions. One of the plurality of phased coils is associated with each stator portion, and wherein each stator portion and associated rotor are spaced part from each other by a gap with the one of the plurality of phased coils extending at least partially across the gap.

In another example, the stator defines a first internal recess having an open end and the rotor defines a second internal recess having an open end that faces the open end of the first internal recess. The first phased coil is positioned within the first and second internal recesses such that the first phased coil extends entirely across the gap.

In another example, the stator and rotor are axially spaced apart from each other along the axis such that the gap is an axial gap.

In another example, the stator and rotor are radially spaced apart from each other such that the gap is a radial gap.

In another example, at least a portion of the gap extends obliquely relative to the axis. Optionally, another portion of the gap may extend parallel or perpendicular to the axis.

In another example, at least two stator portions share a common flux path portion for at least two rotor portions of the plurality of rotor portions.

In another example, the stator and/or rotor include teeth that are formed from a powdered metal material.

These and other features of the present invention can be best understood from the following specification and drawings, the following of which is a brief description.

### BRIEF DESCRIPTION OF THE DRAWINGS

FIG. 1 is a schematic view of a vehicle using transverse flux, switched reluctance motors to drive each wheel.

FIG. 2 is a schematic view of a radially spaced transverse flux, switched reluctance motor as found in the prior art.

FIG. 3 is a schematic view of one example of a transverse flux, switched reluctance motor utilizing C-shaped stators and I shaped rotors with the stators being axially spaced along a motor axis of rotation.

FIG. 4 is a schematic view of another example of a transverse flux, switched reluctance motor utilizing C-shaped stators and C shaped rotors.

FIG. 5 is a schematic diagram of one example of a cooling circuit used in a switched reluctance motor.

FIG. 6 is a schematic view of a switched reluctance motor configuration using a shared stator.

FIG. 7A is a schematic view of a switched reluctance motor having an axial gap with an increased coil area extending over the gap.

FIG. 7B is a schematic view of one example of a switched reluctance motor having a radial gap with an increased coil area extending over the gap.

FIG. 7C is a schematic view of another example of a switched reluctance motor having a radial gap with an increased coil area extending over the gap.

FIG. 8 is a schematic view of a switched reluctance motor configuration with an increased gap diameter.

FIG. 9 is a schematic view of a switched reluctance motor configuration where the stator and/or rotor are formed from a powered metal material.

FIG. 10 is a schematic view of a switched reluctance motor configuration having an angled gap.

### DETAILED DESCRIPTION OF THE PREFERRED EMBODIMENT

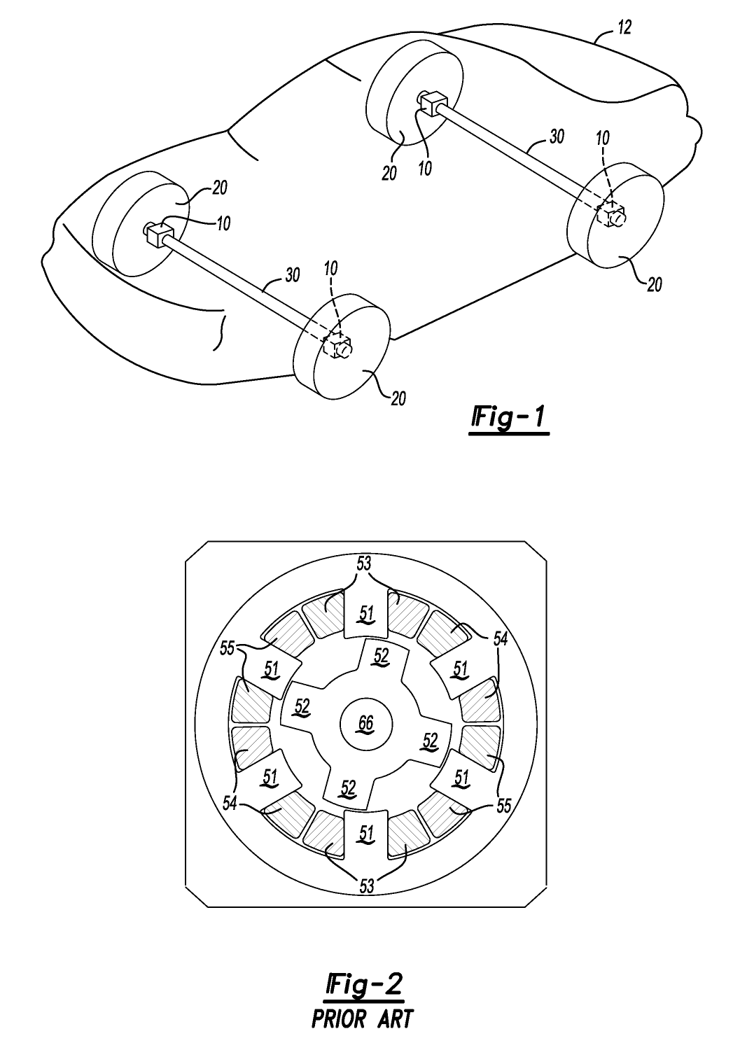

The embodiment of FIG. 1 relates to a traction motor 10 for use in an electric drive train for an automobile 12. One traction motor 10 is placed on a shaft 30 near each of four wheels 20. In the illustrated example the motor is being used in a hybrid electromechanical braking system. The traction motor comprises a transverse flux, switched reluctance motor that can be utilized in any number of different applications where a switched reluctance transverse flux machine would be beneficial.

As shown in FIG. 2, known standard switched reluctance motors in the prior art are composed of a set of three phase windings 53, 54, 55, each of which is wound on a stator pole 51. Each switched reluctance machine design has a certain number of suitable combinations of stator poles 51 and rotor poles 52. The motor is excited (caused to move) by a sequence of current pulses applied at each phase winding 53, 54, 55. The individual phase windings 53, 54, 55 are consequentially energized, forcing the electric field within the switched reluctance machine to change alignment. The rotor poles 52 then shift to align themselves with the newly changed electric field and rotational motion is created.

When each new phase charges up, the electric field within the switched reluctance machine realigns itself with the stators that correspond with the charged phase causing the rotor poles 52 to shift and realign themselves with the electric field. Using this process the rotor 66 can be made to sequentially shift alignment from one phase to the next; causing a full 360 degrees of rotation after each phase has been activated twice. If the phase windings 53, 54, 55 are sequentially charged and discharged fast enough then the rotation can reach sufficient speeds and generate sufficient torque for most applications. Typically the phases are spread radially in a single ring around the shaft as illustrated in FIG. 2. This design introduces downsides including a very harsh fault intolerance, and the necessity of intricate phase windings to accommodate for adjacent phases.

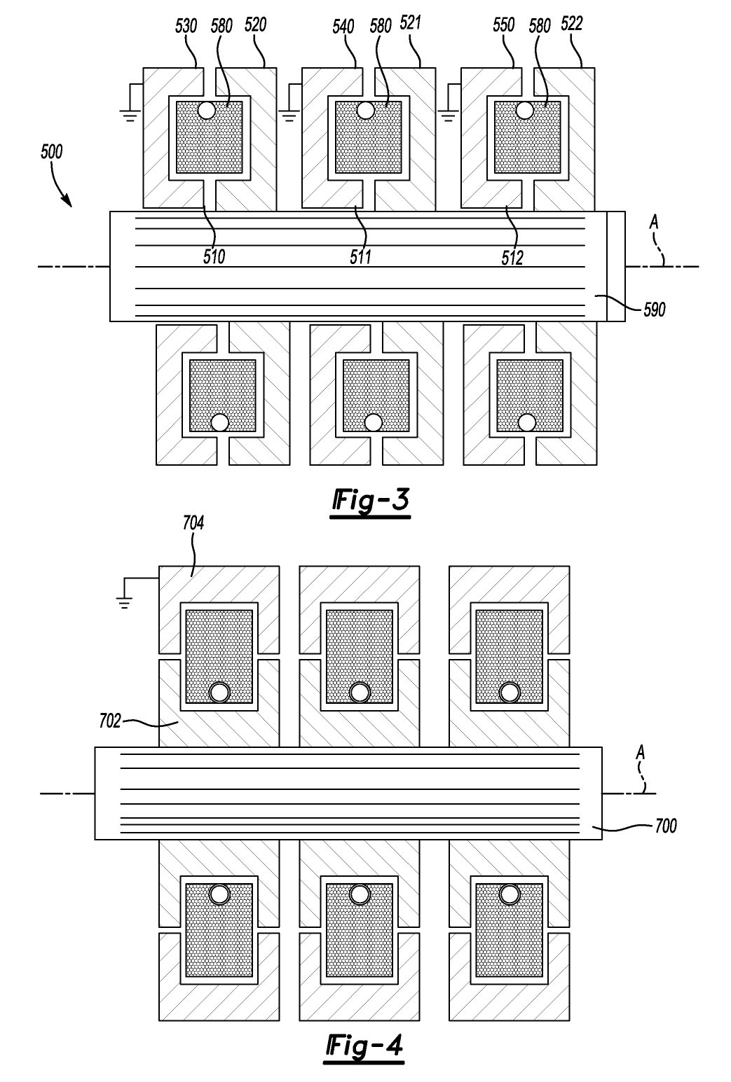

An example of an improved transverse flux, switched reluctance motor 500 with a stator and rotor is shown in FIG. 3. This switched reluctance motor 500 includes phases 530, 540, 550 that are spaced axially along a shaft 590. In this configuration each phase 530, 540, 550 has its own physical and electrical coil 580. The stator is comprised of a plurality of stator portions 510, 511, 512 with one stator portion being associated with each phase 530, 540, 550. The motor includes a plurality of phased coils 580, with one phased coil being associated with each stator portion. The rotor is comprised of a plurality of rotor portions 520, 521, 522 that are axially spaced apart from associated stator portions 510, 511, 512 by a gap. Each gap in the flux path defines an open gap plane between a magnetic field of the stator portion and a magnetic field of the rotor portion. The stator portions 510, 511, 512 are aligned with each other, and rotor portions 520, 521 522 on the shaft 590 are offset for each phase 530, 540, 550. Each axially spaced phase 530, 540, 550 is fired up sequentially. This forces a mechanical rotation similar to the rotation in a radially spaced transverse flux machine.

In an exemplary embodiment, the first stator portion 510 is lined up with the other stator portions 511, 512 in a column parallel to the rotor shaft 590. The first rotor portion 520 for phase 530 is initially lined up with the first stator portion 510. The next phase placed axially on the shaft 590 has rotor portion 521 offset from the first phase's 530 rotor portion 520. The third phase 550 placed axially along the shaft 590 has stator portion 512 offset from both the first phase 530 and the second phase 540. The pattern can be modified to allow for any number of phases. However, the industry standard is to use three phases.

The axial spacing of the three phases 530, 540, 550 allows the motor to be built out of less material, and dramatically reduces the complexity of the windings. Radially spaced windings (like the ones utilized in FIG. 2) needed to be complex for the phase windings 53, 54, 55 to accommodate each of the phases immediately adjacent to them. In the example shown in FIG. 3 the windings can be constructed as a single coil per phase, which dramatically reduces the complexity. This allows for a lighter design as less material in the windings is wasted in non-essential winding components, such as end turn windings. This lighter design configuration and the simpler winding allows additional features to be implemented that were previously impractical or impossible.

A modular assembly design can utilize axially spaced phases. Further, an axially spaced switched reluctance motor can comprise a non-modular assembly in which the switched reluctance motor to be assembled as one step. A benefit provided by a non-modular assembly is that the switched reluctance motor can be built smaller. This is made possible because certain components built into each module which are necessary for a modular design are not necessary and can be removed. Removing the modular components allows a smaller construction and a lighter weight. Additionally, non-modular assemblies can be “tailor made” to specific applications much easier than modular assemblies. FIG. 3 and FIG. 4 illustrate two possible non-modular designs.

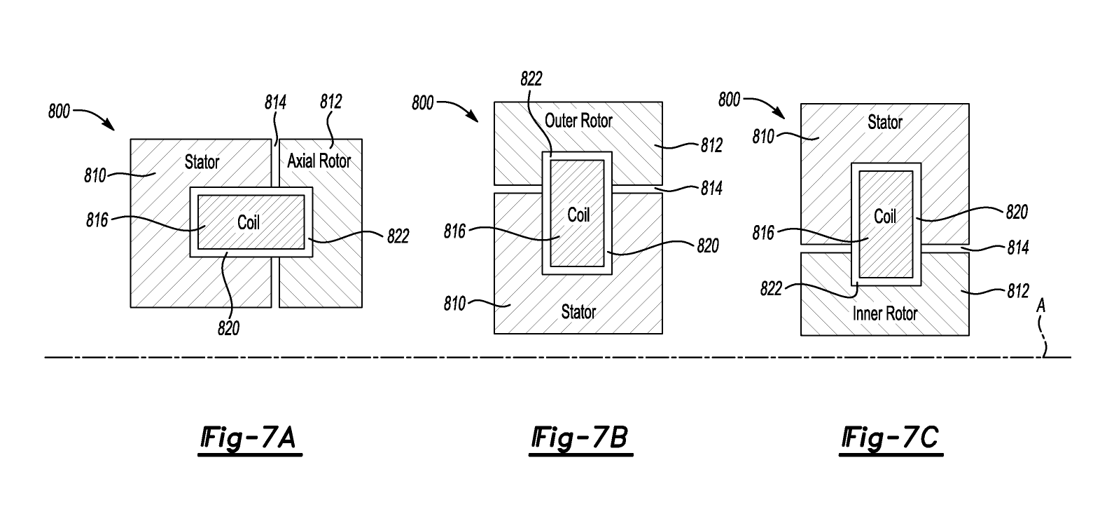

FIG. 4 uses a standard rotor shaft 700 with a rotor comprising a plurality of C-shaped rotor portions 702 attached to the shaft 700 with one rotor portion corresponding to an associated phase. Also, a stator comprising a plurality of C-shaped stator portions 704 is used. The design of FIG. 7 provides pairs of stator portions 704 and rotor portions 702 that are axially spaced apart from each other along the axis A. The motor includes a plurality of phased coils with one phased coil being associated with each stator portion. Within each pair, the stator portion 704 and rotor portion 702 are radially spaced apart from each other by a radial air gap. Each radial air gap in the flux path defines an open gap plane between a magnetic field of the stator portion and a magnetic field of the rotor portion. Each phased coil extends at least partially across the gap.

FIG. 3 uses a rotor shaft 590 with C-shaped rotors 520, 521, 522 and C-shaped stators 510, 511, 512. As discussed above, design of FIG. 3 results in an axial air gap. The advantages and disadvantages of each design vary dependant on the particular application. A person skilled in the art would be capable of determining an appropriate stator/rotor configuration for any given application. Radial gaps are more tolerant of axial runnout. Axial gaps are more tolerant of radial runnout.

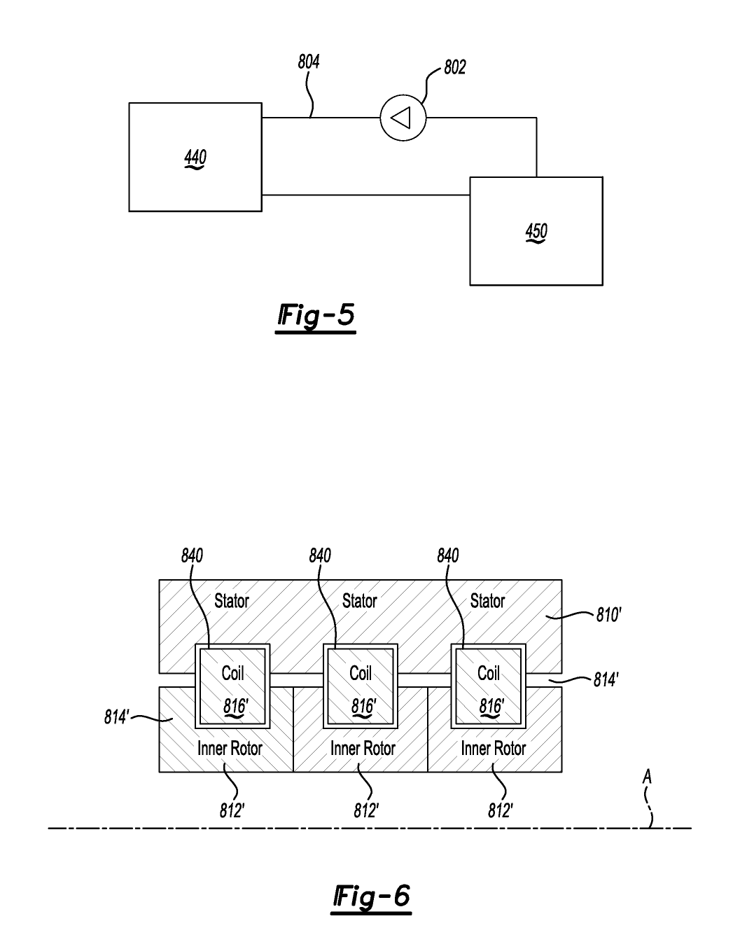

In one example shown in FIG. 5, a cooling circuit can be provided with a fluid path 804 and a pump 802. The pump 802 directs cooling fluid through the cooling loop 440 and then outwardly to a heat exchanger 450. Heat is taken out of the refrigerant circulated through the fluid path 804 at the heat exchanger 450. Any number of methods for taking heat out of the refrigerant can be utilized. As an example, the heat exchanger could be placed in the path of a fan driven by the motor shaft. Also, more elaborate refrigerant systems including a compressor, an expansion device, etc. can be utilized. Again, a worker of ordinary skill in the art would recognize how to incorporate an appropriate refrigerant system.

As described above, FIGS. 3-6 show examples of transverse flux, switched reluctance motors that are lighter in weight and which produce higher torque that prior configurations. Further, these motors have reduced assembly costs and require less packaging space than traditional motor designs.

FIGS. 7A-10 show additional examples of stator/rotor configurations as used in a transverse flux switched reluctance motor such as that shown in FIGS. 3-4 for example. For configurations such as those shown in FIGS. 3-4, the switched reluctance motor would include a plurality of stator/rotor portion pairs 800 as shown in each of the examples set forth in FIGS. 7A-7C. The stator/rotor portion pairs 800 would be spaced apart from each other along an axis A that is defined by a rotating shaft 590 and 700 as shown in FIGS. 3-4.

FIG. 7A shows a stator/rotor pair 800 with a stator 810 and a rotor 812 that are spaced apart from each other by a gap 814. A first phased coil 816 is positioned between the stator 810 and rotor 812 as described above. The coil 816 is configured to extend at least partially across the gap 814.

In the example of FIG. 7A, the stator 810 and the rotor 812 are axially spaced apart from each other along the axis such that the gap 814 comprises an axial gap defining the gap plane. The coil 816 extends entirely across the gap 814 such that portions of the coil 816 are surrounded by both the stator 810 and rotor 812.

In the example of FIG. 7B, the stator 810 and the rotor 812 are radially spaced apart from each other such that the gap 814 comprises a radial gap that defines the gap plane. The stator 810 is positioned radially inward relative to the rotor 812. The coil 816 extends entirely across the gap 814. The example shown in FIG. 7C is similar to 7B but the positions of the stator 810 and rotor 812 are switched.

In each of the examples shown in FIGS. 7A-7C, the stator 810 defines a first internal recess 820 having an open end and the rotor 812 defines a second internal recess 822 having an open end that faces the open end of the first internal recess 820. The coil 816 is positioned within the first 820 and second 822 internal recesses such that the coil 816 extends entirely across the gap 814. The first internal recess 820 is larger than the second internal recess 822 such that a larger portion of the coil 816 is surrounded by the stator 810 than by the rotor 812.

Further, in each of these examples, the stator 810 comprises a first C-shaped component and the rotor 812 comprises a second C-shaped component. The C-shaped stator 810 and rotor 812 are positioned such that the coil 816 is enclosed within a magnetic path formed between the stator 810 and the rotor 812.

The configurations set forth in FIGS. 7A-7C provide for an increased coil area extending over the gap 814 and/or using salient poles on both the stator 810 and rotor 812. By having the coil area transgressing the gap 814, a maximum winding area is provided. It should be understood that in a motor configuration with multiple phases, each stator portion and associated rotor portion would include one phased coil of a plurality of phased coils.

In the example shown in FIG. 6, a stator 810′ shares a common flux path portion that is shared by a rotor having multiple rotor portions 812′. The stator 810′ can be formed as a single-piece component or could be made up of segments that are attached to each other. In the example shown, the stator 810′ includes a plurality of stator portions each having a recess 840, with each recess 840 facing an associated rotor portion 812′ for each phase. A phased coil 816′ is positioned in each recess 840. In the example shown, the stator 810′ is spaced radially outward of the rotors 812′ by a gap 814′; however, the reverse configuration could also be used. This configuration allows shared stator iron between stator phases, which provides a weight savings.

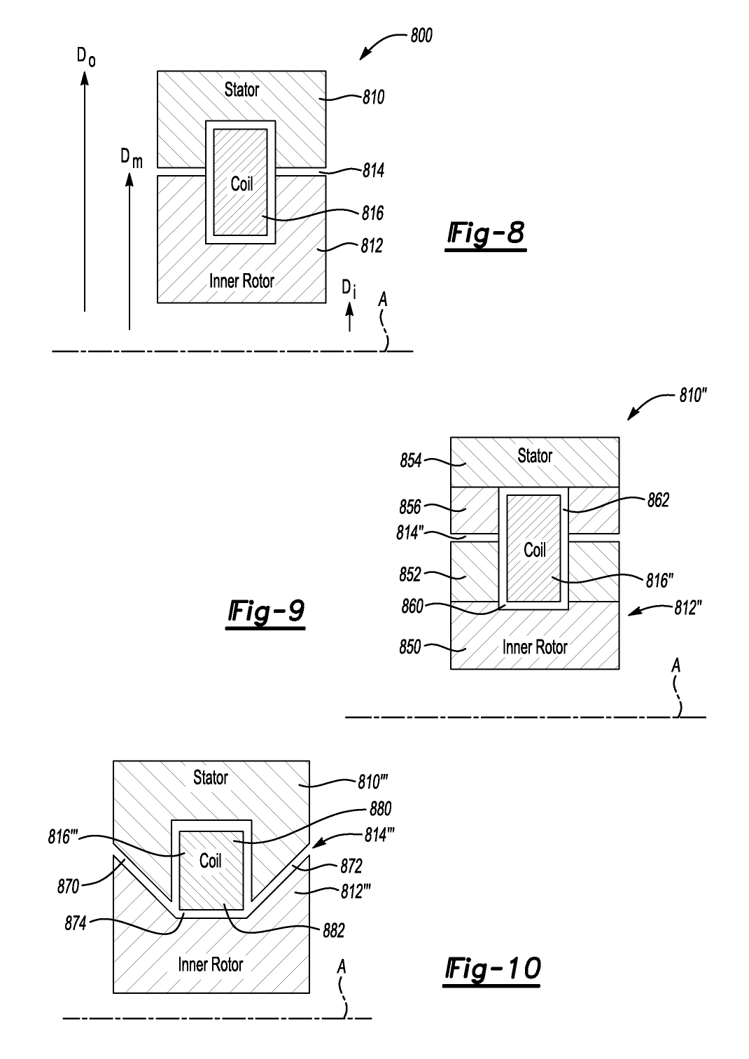

In the example of FIG. 8, the rotor 812 and the stator 810 are radially spaced apart from each other with one of the rotor 812 and the stator 810 defining an outermost diameter Do and the other of the stator 810 and the rotor 812 defining an innermost diameter Di. FIG. 11 shows the stator defining Do; however, a reverse configuration where the rotor 812 defines Do could also be used. The gap 814 defines a middle diameter Dm that is closer to the outermost diameter Do than the innermost diameter Di. By pushing the gap 814 to a larger diameter, more torque can be generated for a given flux in the gap 814.

In the example of FIG. 9, each rotor/stator pair includes a rotor 812″ that has a hub 850 with a first set of teeth 852 and a stator 810″ that includes a yoke 854 with a second set of teeth 856. One or both of the first 852 and the second 856 sets of teeth are comprised of a powered metal material. In one example, a powered iron material is used; however, other types of powdered metal materials could also be used. Forming the stator and/or rotor from this type of material provides for a more simplified manufacturing.

In this example, the first set of teeth 852 includes a first removed area 860 and the second set of teeth 856 includes a second removed area 862. The coil 816″ is positioned within the first 860 and second 862 removed areas such that the coil 816″ extends entirely across the gap 814″.

In the example of FIG. 10, each stator/rotor pair includes a stator 810′″ and a rotor 812′″ spaced apart from each other by a gap 814′″. A single coil 816′″ extends at least partially across the gap 814′″. At least a portion of the gap 814′″ extends obliquely relative to the axis A. In the example shown, a first gap portion 870 extends obliquely relative to the axis A in one direction and a second gap portion 872 extends obliquely relative to the axis A in a different direction. A third gap portion 874, positioned between the first 870 and second 872 gap portions, extends generally parallel to the axis A. This is just one example of a gap configuration, and it should be understood that the gap can be configured to be anywhere within the closed circuit magnetic path.

FIG. 10 shows a radial gap configuration; however, an axial gap configuration could also be utilized where the third gap portion 874 would be generally perpendicular to the axis A. In either configuration, the coil 816′″ includes a first portion 880 that is surrounded by the stator 810′″ and a second portion 882 that is surrounded by the rotor 812′″. The example of FIG. 10 provides for optimization of both axial and radial run-out limits.

Although several embodiments of this invention have been disclosed, a worker of ordinary skill in this art would recognize that certain modifications would come within the scope of this invention. For that reason, the following claims should be studied to determine the true scope and content of this invention.

What is claimed is:

1. A transverse flux, switched reluctance motor comprising:
a stator;
a rotor mounted for rotation relative to said stator about an axis, and
a plurality of phased coils wherein said stator and said rotor are spaced apart from each other by a gap wherein a first phased coil extends at least partially across said gap.

2. The transverse flux, switched reluctance motor according to claim 1 wherein said stator and said rotor are axially spaced apart from each other along said axis such that said gap comprises an axial gap.

3. The transverse flux, switched reluctance motor according to claim 1 wherein said stator and said rotor are radially spaced apart from each other such that said gap comprises a radial gap.

4. The transverse flux, switched reluctance motor according to claim 1 wherein said stator defines a first internal recess having an open end and said rotor defines a second internal recess having an open end that faces said open end of said first internal recess, and wherein said first phased coil is positioned within said first and second internal recesses such that said first phased coil extends entirely across a gap plane.

5. The transverse flux, switched reluctance motor according to claim 4 wherein said stator comprises a first C-shaped component and said rotor comprises a second C-shaped component.

6. The transverse flux, switched reluctance motor according to claim 4 wherein said first phased coil is enclosed within said first and second internal recesses of said stator and said rotor.

7. The transverse flux, switched reluctance motor according to claim 4 wherein said first internal recess is larger than said second internal recess such that a larger portion of said first phased coil is surrounded by said stator than by said rotor.

8. The transverse flux, switched reluctance motor according to claim 1 wherein said stator comprises a plurality of stator portions spaced apart from each other along said axis, and wherein said rotor comprises a plurality of rotor portions with each rotor portion being associated with corresponding stator portions, and wherein one of said plurality of phased coils is associated with each stator portion, and wherein each stator portion and associated rotor portion are spaced apart from each other by a gap with said one of said plurality of phased coils extending at least partially across said gap.

9. The transverse flux, switched reluctance motor according to claim 8 wherein at least two of said plurality of stator portions share a common flux path portion for at least two rotor portions of said plurality of rotor portions.

10. The transverse flux, switched reluctance motor according to claim 1 wherein said stator and said rotor are radially spaced apart from each other with one of said rotor and said stator defining an outermost diameter and the other of said rotor and said stator defining an innermost diameter, and wherein said gap defines a middle diameter that is closer to said outermost diameter than said innermost diameter.

11. The transverse flux, switched reluctance motor according to claim 1 wherein said rotor includes a hub with a first set of teeth and said stator includes a yoke with a second set of teeth, and wherein at least one of said first and said second sets of teeth is comprised of a powered metal material.

12. The transverse flux, switched reluctance motor according to claim 11 wherein said first set of teeth include a first removed area and said second set of teeth include a second removed area, and wherein said first phased coil is positioned within said first and second removed areas such that said first phased coil extends entirely across said gap.

13. The transverse flux, switched reluctance motor according to claim 1 wherein at least a portion of said gap extends obliquely relative to said axis.

14. The transverse flux, switched reluctance motor according to claim 13 wherein at least another portion of said gap is oriented either parallel or perpendicular to said axis.

15. The transverse flux, switched reluctance motor according to claim 13 wherein said first phased coil includes a first portion that is surrounded by said stator and a second portion that is surrounded by said rotor.

16. The transverse flux, switched reluctance motor according to claim 1 wherein said first phased coil includes a first portion that is surrounded by said stator and a second portion that is surrounded by said rotor.

17. A transverse flux, switched reluctance motor comprising:
a stator;
a rotor mounted for rotation relative to said stator about an axis, and
a plurality of phased coils wherein said stator and said rotor are spaced apart from each other by a gap, and wherein at least a portion of said gap extends obliquely relative to said axis.

18. The transverse flux, switched reluctance motor according to claim 17 wherein at least another portion of said gap is oriented either parallel or perpendicular to said axis.

19. The transverse flux, switched reluctance motor according to claim 17 wherein said stator defines a first internal recess having an open end and said rotor defines a second internal recess having an open end that faces said open end of said first internal recess, and wherein a first phased coil is positioned within said first and second internal recesses such that said first phased coil extends entirely across said gap.

20. A transverse flux, switched reluctance motor comprising:
a stator having a plurality of stator portions spaced apart from each other along an axis;
a rotor mounted for rotation relative to said stator about said axis, said rotor having a plurality of rotor portions with each rotor portion being associated with corresponding stator portions,
a plurality of phased coils wherein one of said plurality of phased coils is associated with each stator portion, wherein at least two of said plurality of stator portions share a common flux path portion for at least two rotor portions of said plurality of rotor portions.
